(19) United States
(12) Patent Application Publication
(10) Pub. No.: US 2012/0229835 A1
(43) Pub. Date: Sep. 13, 2012

(54) IMAGE PROCESSING APPARATUS AND OPERATING METHOD THEREOF

(75) Inventor: Masaki Tawada, Osaka (JP)

(73) Assignee: Sharp Kabushiki Kaisha, Osaka (JP)

(21) Appl. No.: 13/413,972

(22) Filed: Mar. 7, 2012

(30) Foreign Application Priority Data
Mar. 10, 2011 (JP) 2011-052299

(51) Int. Cl. G06F 15/00

(52) U.S. Cl. 358/1.13

(57) ABSTRACT

An image processing apparatus includes: an input unit that inputs image data; a setting unit that sets, on the input image data, a sub process to be executed simultaneously with or subsequent to a main process; a determining unit that determines whether user specifying information or data type specifying information specifying the input image data inhibits setting or execution of a prescribed sub process on the input image data; and a limiting unit that inhibits setting or execution inhibited for the prescribed sub process, if the user specifying information or data type specifying information inhibits either setting or execution of the prescribed sub process.

### CROSS-REFERENCE TO RELATED APPLICATION

This nonprovisional application claims priority under 35 U.S.C. §119(a) on Patent Application No. 2011-052299 filed in Japan on Mar. 10, 2011, the entire contents of which are hereby incorporated by reference.

### BACKGROUND OF THE INVENTION

### Field of the Invention

The present invention relates to an image processing apparatus capable of preventing leakage of important documents, as well as to a method of operating the apparatus.

A multifunction peripheral (MFP) has been known as one type of image processing apparatuses as electronic equipment. An MFP has a plurality of functions such as copying, printing, transmitting a facsimile (hereinafter facsimile will be also denoted as FAX) and scanning.

Recently, MFPs come to be widely used, not only in companies but also in general households. An MFP allows the user to easily copy, send FAX and print. Specifically, it is possible to easily copy a document read by a reading device such as a scanner, to convert the document to a FAX format or electronic mail format and to send to a desired destination, or to transmit/receive a document created, for example, by a computer and to have the document printed.

MFPs capable of color output come to be more dominant than MFPs capable of monochrome (black and white) output, and color prints are outnumbering monochrome prints. Transmitted data are also more dominantly color data than monochrome data. It is also noted that reading accuracy of a scanner and printing accuracy of a printer have been remarkably improved.

Japanese Patent Laying-Open No. 7-30694 (hereinafter referred to as '694 Reference) discloses an apparatus having both copying and facsimile transmitting functions in which a plurality of tasks (for example, copying and FAX transmission) are executed on a read document by one operation to reduce total processing time.

Japanese Patent Laying-Open No. 11-46299 (hereinafter referred to as '299 Reference) discloses an image input/output apparatus having a function of preventing counterfeiting of bank note or the like. If an input image is determined to be a specific type of document such as a bank note, the image input/output apparatus inhibits storage and printing of the image to prevent counterfeiting of the document.

In an apparatus capable of simultaneously executing copying and transmitting processes such as disclosed in '694 Reference, if a document of interest is an important document for in-house use (internal use only) and a user inadvertently executes simultaneous processing of a plurality of tasks on the document, it is possible that the document is not only copied but also simultaneously transmitted by FAX to the outside. Even if it is the case that users of the MFP usually handle such documents frequently and are familiar with the use of MFP, there still remains such a possibility.

The method disclosed in '299 Reference may be applied to prevent leakage of important document to the outside. In that case, however, not only FAX transmission but also copying of the important document for internal use would be limited, and such limitation is inconvenient for the user.

### SUMMARY OF THE INVENTION

In view of the foregoing, it is desirable to provide an image processing apparatus capable of preventing leakage of important document when a plurality of processes are set and executed on the read image data at one time by the user, as well as to provide an operating method therefor.

According to an aspect, the present invention provides an image processing apparatus, including: an input unit that inputs image data; a setting unit that sets, on the input image data, a sub process to be executed simultaneously with or subsequent to a mainly executed process; a determining unit that determines whether at least one of user specifying information and data type specifying information specifying type of the input image data inhibits setting or execution of a prescribed sub process on the input image data; and a limiting unit that inhibits, if it is determined that at least one of the user specifying information and the data type information of the input image data inhibits either setting or execution of the prescribed sub process, the setting or execution inhibited for the prescribed sub process.

Preferably, the image processing apparatus further includes a storage unit that stores a table defining correspondence relation between at least one of the user specifying information and the image data type information and information indicating inhibition/permission of either setting or execution of the sub process; wherein the determining unit determines whether at least one of the user specifying information and the data type information inhibits either setting or execution of a prescribed sub process, by looking up the table.

More preferably, at least one of the user specifying information and the data type information is the user specifying information, and the determining unit determines whether or not the user successfully authorized to log-in to the image processing apparatus is inhibited from setting or execution of a prescribed sub process on the image data; or at least one of the user specifying information and the data type information is the data type specifying information of the input image data, the type is specified by information representing degree of importance of image data, and the determining unit determines, by image processing of input image data, whether the information representing the degree of importance is included in the image data, and if it is determined that the information representing the degree of importance is included in the image data, determines whether setting or execution of a prescribed sub process on the image data is inhibited, by looking up the table.

More preferably, the determining unit determines whether or not conditions for exception for executing the inhibited prescribed sub process are satisfied; and if it is determined that the conditions for exception are satisfied, the limiting unit executes the inhibited prescribed sub process.

The present invention also provides a method of operating an image processing apparatus, including the steps of: inputting image data to the image processing apparatus; for the input image data, setting a sub process to be executed simultaneously with or subsequent to a mainly executed process; determining whether at least one of user specifying information and data type specifying information specifying type of the input image data inhibits setting or execution of a prescribed sub process on the input image data; and if it is determined that at least one of the user specifying information and the data type information of the input image data inhibits setting or execution of the prescribed sub process, inhibiting the setting or execution inhibited for the prescribed sub process.

By the present invention, in accordance with the limitation set for the user using the image processing apparatus and the degree of importance of the document, setting by the user of a secondary process (sub job) to be executed simultaneously with or successively to a main process (main job) can be limited. Specifically, if the user is a user inhibited from setting a sub job, setting of the sub job is inhibited. Therefore, inadvertent setting of a sub job by an unauthorized user can be prevented.

By the present invention, even when a sub job is set by an authorized user, execution of the sub job can be limited. Specifically, if the document is of high importance, execution of the sub job can be inhibited regardless of the user authority. Therefore, execution of an inadvertently set sub job and leakage of confidential document to the outside can be prevented.

By setting conditions for exception for inhibiting execution of a sub job, it becomes possible to prevent excessive decrease in operability of the image processing apparatus caused by the inhibition of the sub job. Further, by appropriately setting the conditions for exception, good balance between the risk of leakage of secret document and the convenience can be attained in accordance with characteristics of the organization (such as frequency of handling confidential documents) where the image processing apparatus is used.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram schematically showing an internal configuration of an image processing apparatus in accordance with an embodiment of the present invention.

FIG. 2 is a flowchart representing a control structure of a program for preventing leakage of important document in the image processing apparatus in accordance with an embodiment of the present invention.

FIG. 3 shows an example of a user authentication screen image.

FIG. 4 shows an example of a table saving user names and inhibition/permission of job setting in correspondence with each other.

FIG. 5 shows an example of a job setting screen image in which setting of sub jobs is inhibited.

FIG. 6 shows an example of a job setting screen image in which setting of sub jobs is not inhibited.

FIG. 7 shows examples of stamps put on important documents.

FIG. 8 shows an example of a table saving document types and inhibition/permission of job execution in correspondence with each other.

FIG. 9 is a flowchart representing a control structure of a program for preventing leakage of important document with exception, in the image processing apparatus in accordance with an embodiment of the present invention.

### DESCRIPTION OF THE PREFERRED EMBODIMENTS

In the following embodiments, the same components are denoted by the same reference characters. Their names and functions are also the same. Therefore, detailed description thereof will not be repeated.

The image forming apparatus in accordance with the present embodiment is a digital multifunction peripheral having a plurality of functions including scanner function, copy function, facsimile function and printer function. In the following, an “image” means not only the displayed image but also image data. The “image data” means not only the image data but also text data as well as mixed data including images and texts.

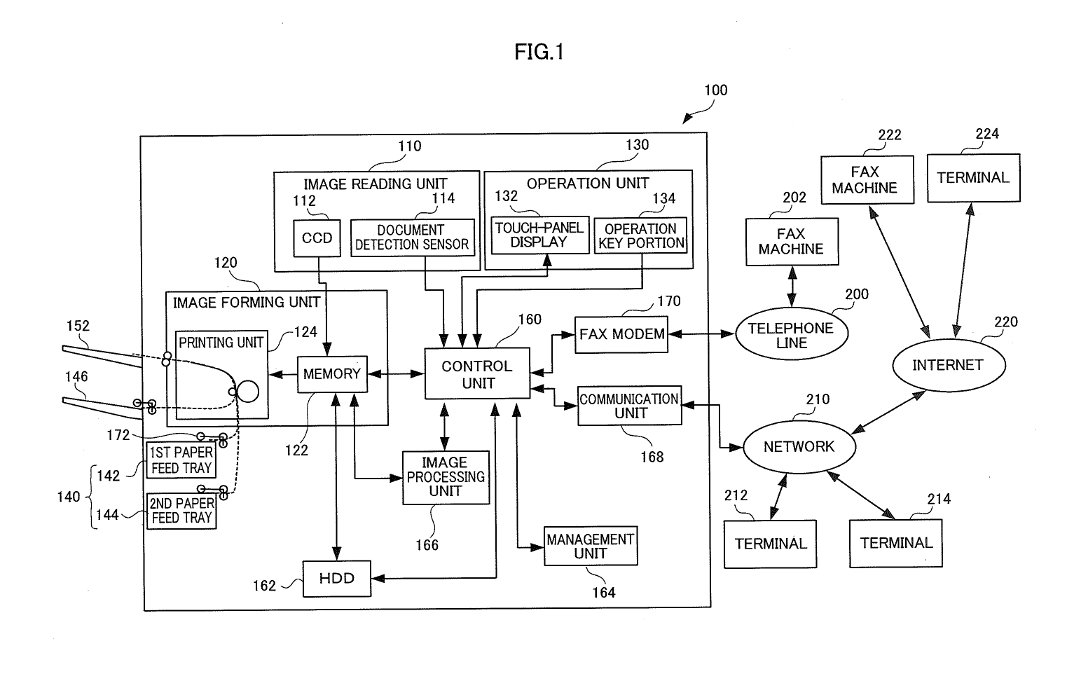

In the following, various units and portions of an image processing apparatus 100 in accordance with an embodiment of the present invention will be described with reference to FIG. 1.

An image reading unit 110 reads a document and creates image data. Image reading unit 110 may include, for example, a CCD (Charge Coupled Device) 112 for reading an image, and a document detection sensor 114 for detecting a document set on a platen or on an automatic document feeder (ADF).

An operation unit 130 includes an operation key portion 134 provided with various input keys (hardware keys) and a touch-panel display 132 having a touch-panel arranged on a display panel such as an LCD (Liquid Crystal Display). By screen images displayed on touch-panel display 132, a user confirms a state of image processing apparatus 100 and confirms status of job processing. It is possible for the user to set functions and instruct operations of image processing apparatus 100 by selecting keys displayed on touch-panel display 132 on the touch-panel superposed on the display panel (by pressing corresponding portions on the touch-panel). Whether or not a displayed key is pressed on touch-panel display 132 may be determined using a known technique. By way of example, correspondence, relation between two-dimensional coordinates of the touch-panel and two-dimensional coordinates of the display panel is determined beforehand, and whether or not a pressed position on the touch-panel is within a region of a character, figure or the like displayed on the display panel may be determined.

Operation unit 130 may be provided with means for inputting authentication information, allowing input of authentication information of users using image processing apparatus 100. Possible method of inputting user authentication information may include direct input of user code, input by reading information of an ID card, and input by reading biometric information (such as fingerprint) of the user. User authentication is made possible by any of these methods. It is also possible for the user to instruct interruption, that is, to suspend a recording job and insert another job, through operation unit 130.

A control unit 160 monitors user operations on touch-panel display 132 and input keys provided on operation unit 130, and displays, on touch-panel display 132, any information to be notified to the user, such as information related to the state of image processing apparatus 100. A management unit 164 is a memory for storing control information, setting information and the like of image processing apparatus 100. Control unit 160 controls overall operation of image processing apparatus 100 based on the information stored in management unit 164. An image forming unit 120 processes and outputs image data.

Image forming unit 120 includes a memory 122, and a printing unit 124 such as an LSU (Laser Scanning Unit). Image forming unit 120 once stores image data read by image reading unit 110 in memory 122 and, thereafter, stores the image data on memory 122 to an HDD 162. Image forming unit 120 reads the image data stored in HDD 162 to memory 122, transmits the data to printing unit 124, and thus the data is output, printed on recording paper.

HDD 162 stores input image data. HDD 162 is a magnetic storage medium, capable of storing and successively processing huge amount of image data. Thus, image processing apparatus 100 can process instructions from a plurality of users with high efficiency.

An image processing unit 166 is controlled by control unit 160 that receives a user instruction through operation unit 130. Image processing unit 166 reads image data from memory 122, executes instructed image processing, and stores the result in memory 122. Image data as the result of processing is displayed on touch-panel display 132 through control unit 160. Thereafter, the image data on memory 122 is transmitted to printing unit 124 and printed on recording paper, output to a telephone line 200 through a FAX modem 170, or output to a network, 210 through a communication unit 168, in response to a user instruction.

In the following, various modes for executing the functions (copy function, printer function, scanner function and facsimile function) of image processing apparatus 100 will be briefly described.

(Copy Mode)

When image processing apparatus 100 is used as a copy machine, image data of a document read by image reading unit 110 is output as a copy from image forming unit 120.

By CCD 112 provided in image reading unit 110, an image of a document set at a reading position can electronically be read. The read image data is completed as output data (print data) on memory 122, and then stored in HDD 162. If there is a plurality of documents, the reading operation and the storage operation are repeated. Thereafter, based on a processing mode instructed from operation unit 130, image data stored in HDD 162 is successively read at appropriate timing and sent to memory 122. Then, the image data is transferred from memory 122 to printing unit 124, timed with image formation at printing unit 124.

When a plurality of pages of read image data are to be printed, the image data stored page by page in HDD 162 is transferred as output data from HDD 162 to memory 122 and transferred to printing unit 124 timed with image formation at printing unit 124, repeatedly by the number of pages to be output.

Specifically, recording paper is drawn by a pick-up roller (for example, a pick-up roller 172 of a first paper feed tray 142), from any of a first paper feed tray 142, a second paper feed tray, 144 and a manual paper feed tray 146. The drawn recording paper is conveyed through the inside of printing unit 124 by means of a plurality of conveyer rollers (in FIG. 1, cross-sections of these rollers are represented by a plurality of circles). In FIG. 1, conveyer paths of sheets of recording paper drawn from first paper feed tray 142, second paper feed tray 144 and manual paper feed tray 146 are represented by dotted lines. LSU exposes a charged photoreceptor drum (not shown) in accordance with the input image data. Consequently, electrostatic latent image corresponding to the image data is formed on a surface of the photoreceptor drum. The electrostatic latent image on the photoreceptor drum is transferred by a transfer belt to the fed recording paper. Thereafter, the sheet of recording paper is heated and pressed (whereby the image is fixed on the sheet of recording paper), and then discharged to a discharge tray.

(Printer Mode)

When image processing apparatus 100 is used as a printer, the image data received through communication unit 168 is output from image forming unit 120 through memory 122 or the like.

Communication unit 168 is connected to network 210 by wired or wireless manner, and receives image data from terminals 212 and 214 connected to network 210 and from a terminal 224 through the Internet 220. The received image data is sent page by page as output image data to memory 122, and then stored in HDD 162. Then the image data is again sent from HDD 162 to memory 122, transferred to printing unit 124 in the similar manner as in the copy mode described above, and image is formed.

(Scanner Mode)

When image processing apparatus 100 is used, for example, as a network scanner, document image data read by image reading unit 110 is transmitted to an arbitrary terminal 212 or 214 from communication unit 168 through network 210. Here again, by CCD 112 provided in image reading unit 110, the document is read electronically. The read image data of the document is completed as output data on memory 122, and stored in HDD 162. The image data is again sent from HDD 162 to memory 122, and after a communication with a designated transmission destination is established through operation unit 130, transmitted to the designated transmission destination from communication unit 168.

(Facsimile Mode)

As described above, image processing apparatus 100 has FAX modem 170 connected to telephone line 200, and communication unit 168 connected to network 210 and to the Internet 220. Therefore, image processing apparatus 100 can transmit/receive FAX with a facsimile machine 202 through telephone line 200 and can transmit/receive FAX with a facsimile machine 222 through network 210 and the Internet 220.

When image processing apparatus 100 is used as a facsimile machine, data received by FAX from facsimile machine 202 or 222 may be formed as image data in memory 122 and stored in HDD 162 or printed by printing unit 124 in the similar manner as described above. Further, image processing apparatus 100 may read image data from HDD 162, convert the data to a data format for FAX communication and transmit the data to facsimile machine 202 or 222.

In image processing apparatus 100, the user causes image processing apparatus 100 to execute a prescribed process by a touch-operation of a preview image displayed on the touch-panel display 132. Here, image processing apparatus 100 limits setting and execution of a sub job by the user, in accordance with the limitation set on the user and the type (degree of importance) of the document as an object of processing. A sub job means a job additionally set when a specific job is set as a main job (the process to be executed mainly) and executed simultaneously with or following the main job. In the following, a control structure of a program executed by control unit 160 for realizing such limitation will be specifically described.

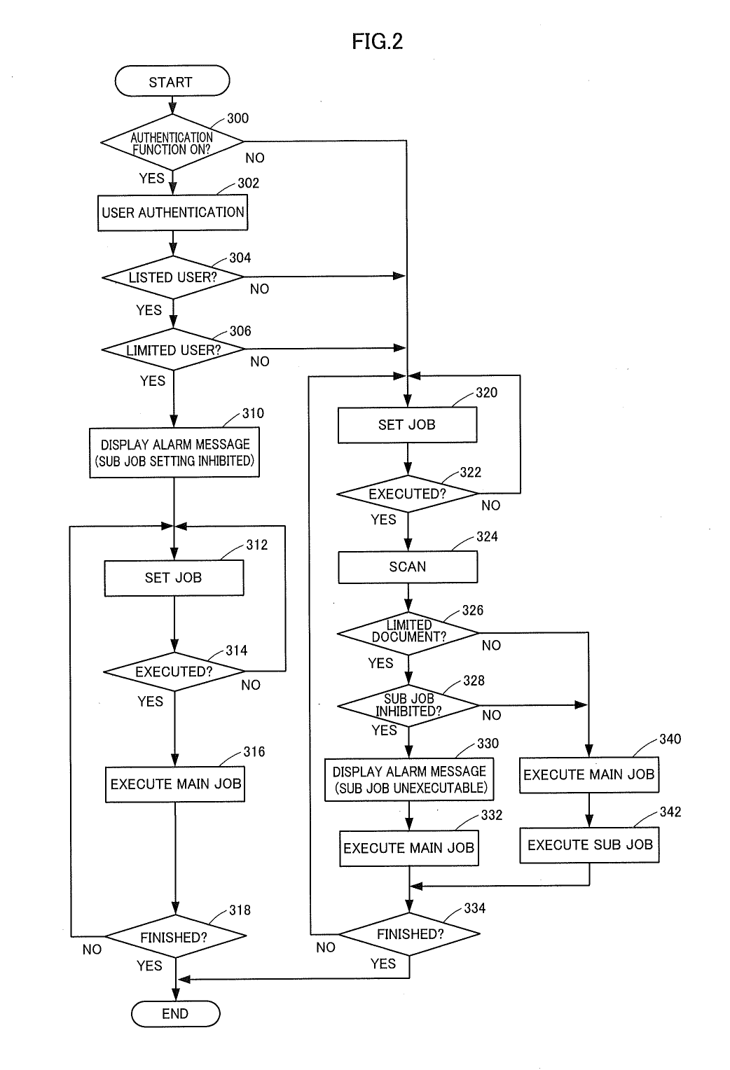

Referring to FIG. 2, at step 300, control unit 160 determines whether or not an authentication function is ON. If it is determined to be ON, the control proceeds to step 302. If it is determined to be OFF, the control proceeds to step 320.

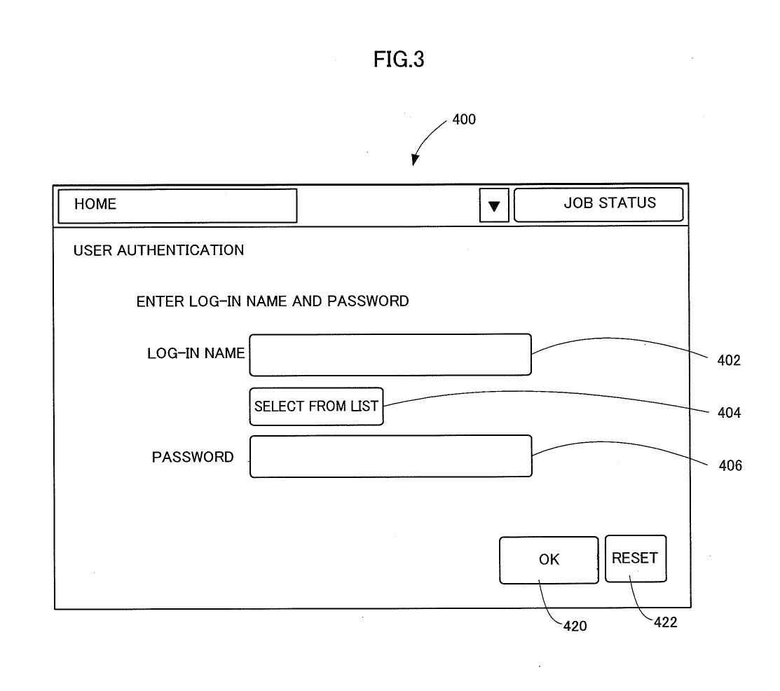

At step 302, control unit 160 authenticates a user who uses image processing apparatus 100. Specifically, an authentication screen image 400 such as shown in FIG. 3 is displayed on touch-panel display 132. Authentication screen image 400 includes a log-in name entering box 402 and a password entering box 406. To enter the log-in name, the user presses a key 404 for selection from a list, and touches and selects his/her name appearing in the displayed list of user names. The selected user name is displayed in log-in name entering box 402. The password is entered using ten keys on operation key portion 134 of operation unit 130.

Alternatively, a partial window including ten keys may be displayed when the user touches password entering box 406, so that the password can be entered using the same. A reset key 422 is for clearing data in log-in name entering box 402 and password entering box 406.

When the user enters the log-in name and the password and presses OK button 420, control unit 160 refers to authentication information using the entered information, and determines whether or not the user is authorized to use image processing apparatus 100. The authentication information may be authorized user names and passwords stored in correspondence with each other in, for example, HDD 162. If user authentication is successful, the control proceeds to step 304. If user authentication fails, the authentication process is repeated.

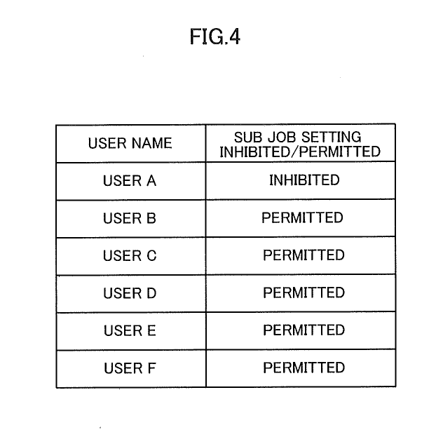

At step 304, control unit 160 determines whether or not the authorized user is a user whose operations are to be limited. Specifically, control unit 160 looks up a limited user table such as shown in FIG. 4 stored in advance in HDD 162, and determines whether or not the name of the user (log-in name) who successfully passed the authentication at step 302 is included. If it is determined that the log-in name is included in the limited user table, control unit 160 reads information (inhibited or permitted) of the corresponding sub job setting, and the flow proceeds to step 306. Otherwise, the flow proceeds to step 320.

The limited user table related to the user has the user names and information related to inhibition/permission of sub job setting saved in corresponding manner. The limited user table may be in any data format. It may include text data or numerical value data. By way of example, in place of user names in text, code numbers allocated user by user may be saved. As to the information related to inhibition/permission of sub job setting, in place of “inhibited” or “permitted”, numerical value “0” or “1” may be saved.

At step 306, control unit 160 determines whether or not the information of inhibition/permission of sub job setting read at step 304 is “inhibited.” If it is determined to be “inhibited,” the control proceeds to step 310. If it is determined not to be “inhibited,” the control proceeds to step 320.

At step 310, control unit 160 displays an alarm message indicating that setting of a sub job is inhibited, on touch-panel display 132.

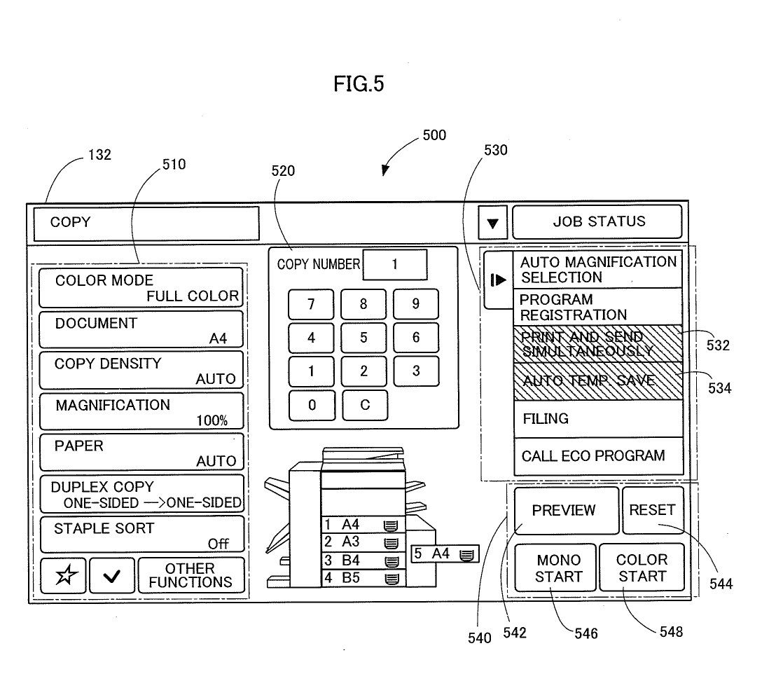

At step 312, control unit 160 displays a job setting screen image in which setting of sub jobs is inhibited on touch-panel display 132, and receives a user operation. By way of example, a screen image 500 shown in FIG. 5 is displayed on touch-panel display 132. The alarm message displayed at step 310 is erased by screen image 500.

At an upper left corner of screen image 500, there is an indication of copy mode. Screen image 500 includes a function setting area 510, a ten-key area 520, an action panel area 530 and a task trigger area 540. On function setting area 510, a plurality of keys (hereinafter also referred to as function setting keys) for setting various functions of image processing apparatus 100 are displayed. Setting related to a main job is done using keys on function setting area 510. In function setting area 510 of FIG. 5, only some of the function setting keys are displayed. Function setting keys not displayed appear when “other function” key is pressed. Ten-key area 520 includes ten keys (numerical keys “0” to “9” and clear key “C”) and a display area for displaying the number of copies. The number of copies is entered by the ten keys. In FIG. 5, the number of copies is set to 1.

On action panel area 530, pieces of information related to assistance, guidance and suggestion related to the operation are displayed. On action panel area 530, if, for instance, a user selects a specific function, functions related to the selected function are displayed. Other functions for the same purpose as the selected function may be displayed.

Setting related to a sub job is done using keys on action panel area 530. In the following, description will be given assuming that copying is the main job, and functions of “print and send simultaneously” and “auto temporary save” are sub jobs, and that keys 532 and 534 are keys for setting related to respective sub jobs.

Here, setting of sub jobs by the logged-in user is inhibited and, therefore, corresponding keys 532 and 534 are inoperable. In order to let the user recognize the inoperable state, keys 532 and 534 are grayed-out (displayed with lower brightness than the surroundings). In FIG. 5, grayed-out portions are hatched.

The function of “print and send simultaneously” is a function of copying a scanned document and simultaneously transmitting the document by FAX. The “auto temporary save” function is a function of automatically saving the data to be copied in a temporary folder of HDD 162. Thus, speedy re-print can be realized simply by designating the file.

Task trigger area 540 is an area on which keys serving as triggers for image processing apparatus 100 to start certain processes are displayed. Specifically, a mono start key 546, a color start key 548, a preview key 542 and a reset key 544 are displayed. Mono start key 546 is to start monochrome copying. Color start key 548 is to start color copying. Preview key 542 is to start a process for once reading a document and displaying a preview image in copying or FAX transmission. Reset key 544 is for clearing all settings.

At step 314, control unit 160 determines whether or not mono start key 546 or color start key 548 on task trigger area 540 is pressed. If it is determined to be pressed, the control proceeds to step 314. Otherwise, the process of step 312 is repeated.

At step 316, control unit 160 executes the main job. Here, the operation is in the copy mode and the main job is copying. Therefore, control unit 16Q executes the process of copy mode as described above in accordance with the conditions set by function setting area 510, and generates a black-and-white or color copy of the document set on image reading unit 110.

At step 318, control unit 160 determines whether or not an instruction to end has been received. By way of example, if a key for log-out is pressed, control unit 160 determines that the instruction to end is received, and ends the program. Otherwise, the control returns to step 312, and the process of following steps is repeated.

As described above, if the logged-in user is a user inhibited from setting sub jobs, the user is permitted only to set the main job by the process of steps 310 to 318, and thus, he/she can execute only the main job.

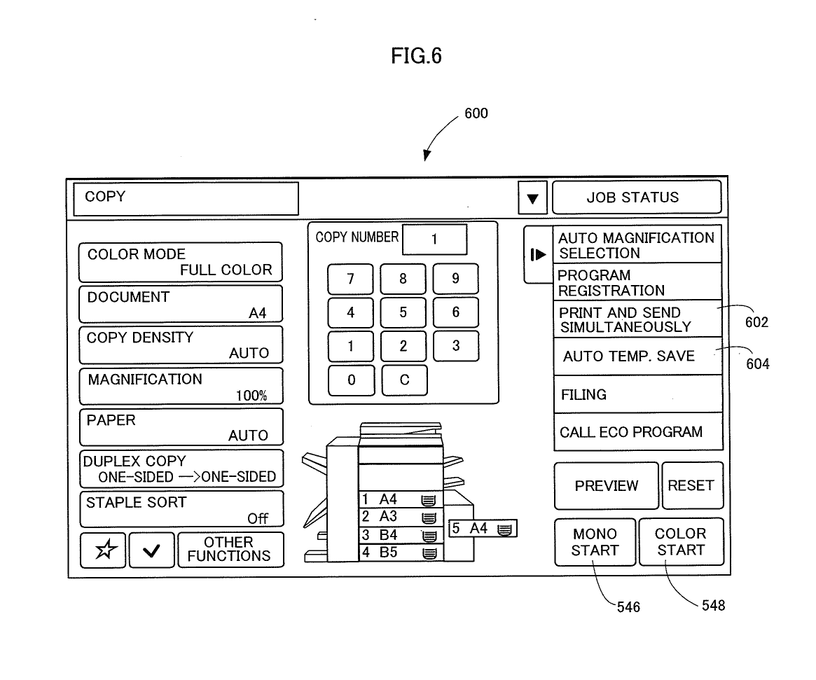

On the other hand, if the logged-in user is not a user inhibited from setting sub jobs, at step 320, control unit 160 displays a job setting screen image allowing setting of sub jobs on touch-panel display 132, to receive a user operation. By way of example, a screen image 600 shown in FIG. 6 is displayed on touch-panel display 132. In screen image 500 shown in FIG. 5, key 532 for setting the function of “print and send simultaneously” and key 534 for setting the “auto temporary save” function are grayed-out and the user cannot operate these keys. In screen image 600, corresponding keys 602 and 604 are displayed in the similar manner as other keys and operable. Screen image 600 is different only in this point from screen image 500. Therefore, description thereof will not be repeated. The user can set not only the main job but also sub jobs as needed. Here, the function of “print and send simultaneously” and the function of “auto temporary save” are set as the sub jobs.

At step 322, control unit 160 determines whether or not mono start key 546 or color start key 548 on task trigger area 540 is pressed. If it is determined to be pressed, the control proceeds to step 314. Otherwise, the process of step 320 is repeated.

At step 324, control unit 160 scans a document set at image reading unit 110 in accordance with the conditions set by function setting area 510, and stores the image data in memory 122.

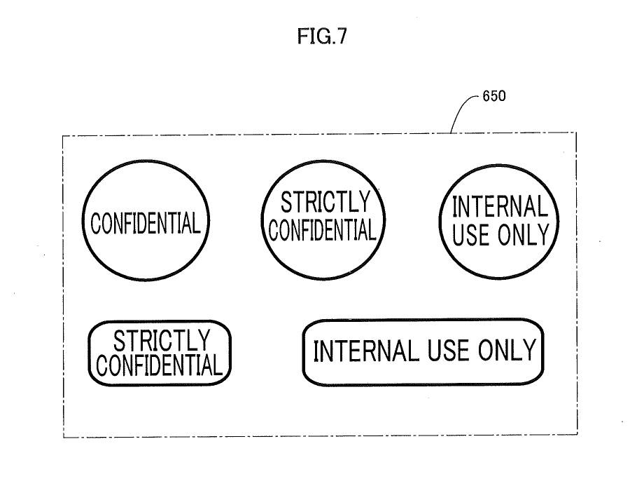

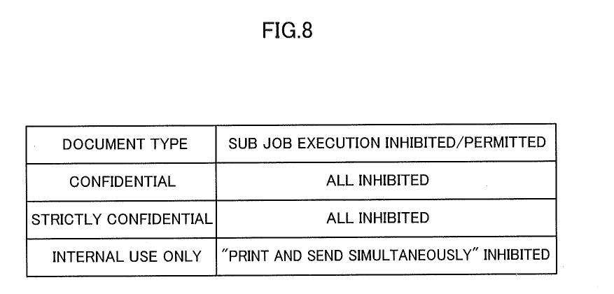

At step 326, control unit 160 determines whether or not the document scanned at step 324 is a document of the type on which execution of a sub-job is inhibited. The document of the type on which execution of a sub-job is inhibited includes documents having such stamps as shown surrounded by chain-dotted lines in FIG. 7. Pieces of information related to this type of documents are stored beforehand, for example, as a limited document table such as shown in FIG. 8, in HDD 162. Control unit 160 causes image processing unit 166 to execute an image recognition process on the image data in memory 122, to determine whether or not the image includes any of the stamps shown in FIG. 7. For instance, the document type “confidential” in FIG. 8 corresponds to the image at the upper left end of FIG. 7. The document type “strictly confidential” corresponds to the upper central image or lower left image of FIG. 7. The document type “internal use only” corresponds to the upper right image or lower right image of FIG. 7. For the image recognition to detect the designated image (any of the image data shown in FIG. 7) from the object image (image data in memory 122), known image processing technique such as block matching may be applied. Thus, description thereof will not be repeated here. If the document is determined to be of the sub-job-inhibited type, that is, if any of the stamps shown in FIG. 7 is detected, the control proceeds to step 328. Otherwise, the control proceeds to step 340.

At step 328, control unit 160 determines whether or not the job set at step 320 is an inhibited sub job as indicated by the “sub job execution inhibited/permitted” corresponding to the “document type” detected at step 326. By way of example, assume that key 602 is pressed at step 320 to set the sub job of printing and sending simultaneously and at step 326, a stamp of internal use only is detected. From the limited document table of FIG. 8, control unit 160 determines that the set sub job is inhibited. By way of example, if key 604 is pressed to set the sub job of auto temporary save at step 320 and the stamp of internal use only is detected at step 326, control unit 160 determines that the set sub job is not inhibited. If key 602 or 604 is pressed and setting related to a sub job is done at step 320 and the stamp of confidential or strictly confidential is detected at step 326 (the document type is confidential or strictly confidential), corresponding cells of “sub job execution inhibited/permitted” are “all inhibited.” Therefore, control unit 160 determines that the set sub job is inhibited. If the set job is determined to be inhibited, the control proceeds to step 330. Otherwise, the control proceeds to step 340.

At step 330, control unit 160 displays an alarm message indicating that execution of the sub job is inhibited, on touch-panel display 132.

At step 332, control unit 160 executes the main job. Specifically, control unit 160 generates a black-and-white or color copy depending on whether mono start key 546 or color start key 548 has been pressed at step 322, using image data scanned at step 324 and stored in memory 122.

At step 334, control unit 160 determines whether or not an instruction to end has been received. If it is determined that the instruction to end is received, the program ends. Otherwise, the control returns to step 320, and the process of following steps is repeated.

At step 340, control unit 160 executes the main job in the similar manner as at step 332.

At step 342, control unit 160 executes the sub job set at step 320, and the control proceeds to step 334. If no sub job is set at step 320, no operation is done by control unit 160 at step 342, and the control proceeds to step 334.

As described above, by the process following step 320, if the authentication function is OFF, or if the logged-in user is a user whose setting of sub job is not inhibited, the user can set a main job and a sub job. If a sub job is set, the jobs are executed in accordance with the degree of importance of the document (document type). Specifically, if it is an important document, only the main job is executed, and otherwise, both the main job and the sub job are executed. If the document is of the type that inhibits execution of the sub job, the sub job (for example, print and send simultaneously) is not executed. It is noted, however, that if the control returns to step 320 after the main job (for example, copying) is executed at step 332 and FAX transmission, for example, is set as the main job, the document of the type that inhibits execution of a sub job can be transmitted by FAX.

As described above, if the logged-in user is a user inhibited from setting a sub job, setting of a sub job is inhibited and thereby execution of a sub job can be inhibited if the document is of importance. Further, even if execution of a sub job is inhibited, the operation can be executed if it is set as a main job. Therefore, it is possible to transmit the document after definitely confirming that the important document is to be transmitted. Thus, inadvertent execution of a sub jot leading to leakage of confidential document to the outside can be prevented.

In the foregoing, an example has been described in which a screen image (screen image 500 of FIG. 5) not allowing setting of sub jobs is displayed for a user inhibited from setting any sub job. The example, however, is not limiting. For instance, a screen image allowing setting of sub jobs may be displayed for a user inhibited from setting any sub job, and execution of the set sub job may be inhibited.

Though an example has been described in which execution of a set sub job is inhibited for an important document, the example is not limiting. For instance, setting of any sub job may be inhibited for an important document, by displaying, for example, the screen image (screen image 500 of FIG. 5) not allowing setting of sub jobs.

Though an example has been described in which “print and send simultaneously” or “auto temporary save” function is set as a sub job, a plurality of sub jobs may be set. In that case, if the limited documents table of FIG. 8 is used and the document has a stamp of internal use only, the “auto temporary save” function is executed while the “print and send simultaneously” function is not executed. In this manner, if the user sets a plurality of sub jobs, preferably, only the permitted sub job is executed in accordance with the document type.

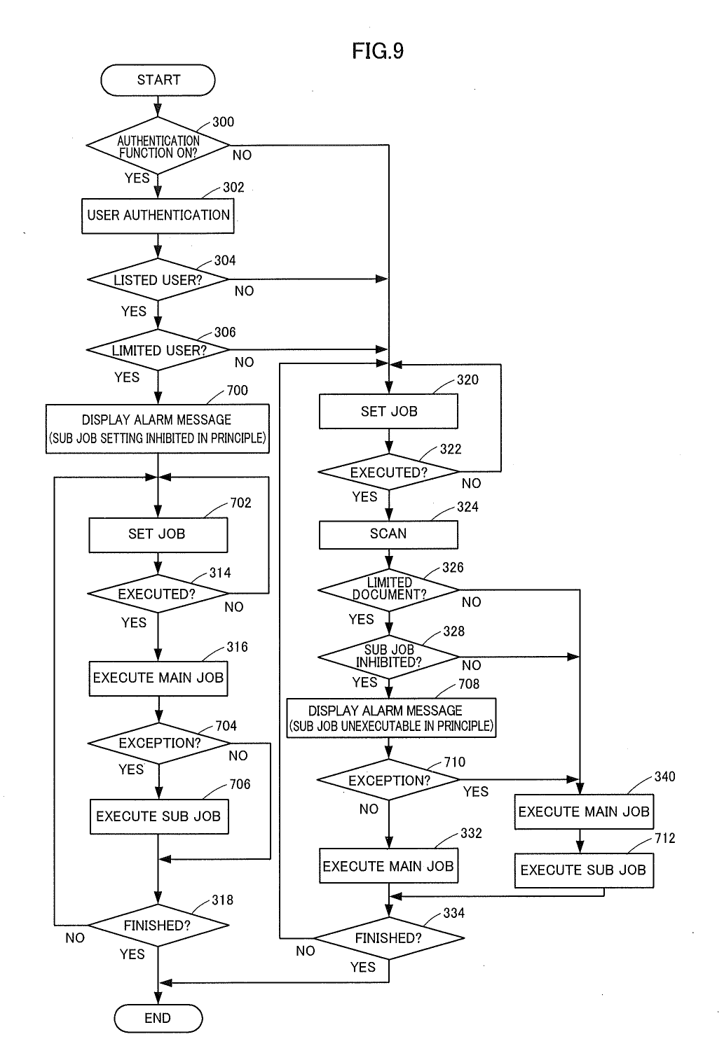

In the foregoing, an example has been described in which a sub job is not executed if the user is inhibited from or the document type does not allow execution of a sub job. The example, however, is not limiting. As shown in the flowchart of FIG. 9, execution of a sub job may be permitted as an exception. The flowchart of FIG. 9 is different from FIG. 8 in that steps 704, 706 and 710 are added and steps 310, 312, 330 and 342 are changed to steps 700, 702, 708 and 712, respectively. Details will be described in the following. Steps bearing the same numbers as in FIG. 8 will not be described again.

At step 700, control unit 160 displays an alarm message that execution of a sub job is inhibited in principle, on touch-panel display 132.

At step 702, control unit 160 displays a job setting screen image allowing setting of a sub job on the touch-panel, to receive a user operation. By way of example, screen image 600 shown in FIG. 6 is displayed on touch-panel display 132. The user can set not only the main job but also a sub job as needed.

If a sub job is set at step 702, at step 704, control unit 160 determines whether or not the set contents of the sub job satisfy conditions for exception. An exception, for example, is that the user selects a transmission function (for example, “print and send simultaneously”) and sets his/her supervisor as a destination. Specifically, organization information, including hierarchical relations among the users and at least information related to transmission destinations (FAX numbers, electronic mail addresses and the like), is stored beforehand in HDD 162. By such an arrangement, control unit 160 can determine, from the organization information, whether the transmission destination information set by the logged-in user corresponds to his/her supervisor. If the conditions for exception are determined to be satisfied, the control proceeds to step 706. Otherwise, the control proceeds to step 318. If no sub job is set at step 702, no operation is done by control unit 160 and the control proceeds to step 318.

At step 706, control unit 160 executes the sub jot set at step 702, and the control proceeds to step 318. Here, the executed sub job is only the sub job that qualifies as an exception. For instance, if “print and send simultaneously” and “auto temporary save” are designated as sub jobs and the transmission destination for “print and send simultaneously” is a destination of the supervisor, the sub job of “print and send simultaneously” is executed, while “auto temporary save” is not executed. If a plurality of transmission destinations are set, preferably, transmission only to the destination that qualifies as an exception should be allowed. Before executing the sub job, preferably, a message such as “sub job is to be executed” is displayed on touch-panel display 132.

As described above, if the logged-in user is a user inhibited from setting a sub job, in principle, only the main job is executed and if conditions for an exception are, satisfied, a sub job can be executed as an exception.

If the logged-in user is not inhibited from setting a sub job, at step 708, control unit 160 displays an alarm message indicating that execution of a sub job is inhibited in principle, on touch-panel display 132.

If a sub job is set at step 320, at step 710, control unit 160 determines whether or not execution of the sub job qualifies as an exception. If it is determined to qualify as an exception, the control proceeds to step 340, at which control unit 160 executes the main job. Otherwise, the control proceeds to step 332. If no sub job is set at step 320, no operation is done by control unit 160, and the control proceeds to step 332.

At step 712, control unit 160 executes the sub job set at step 320, and the control proceeds to step 334. Here, the executed sub job is, as at step 706, only the sub job that qualifies as an exception. Before executing the sub job, preferably, a message such as “sub job is to be executed” is displayed on touch-panel display 132. If no sub job is set at step 320, no operation is done by control unit 160, and the control proceeds to step 334.

As described above, by the process following step 320, if the authentication function is OFF, or if the logged-in user is a user not inhibited from setting a sub job, the user can set a main job and a sub job. If a sub job is set, in accordance with the degree of importance of the document (document type), if it is not an important document, both the main job and the sub job are executed and if it is an important document, only the main job is executed. Even if the document is of importance, a sub job is executed if it is qualified as an exception and conditions for exception are satisfied.

In the foregoing, an example has been described in which the main job is copying and the sub job includes “print and send simultaneously” and “auto temporary save” functions. The example, however, is not limiting. The main job may include, in addition to copying, FAX transmission (including the Internet FAX), printing, scanning, SCAN-TO-E-mail (a function of transmitting a scanned image appended to an e-mail), SCAN-TO-FTP (a function of saving a scanned image in an FTP server), SCAN-TO-HTTP (a function of saving a scanned image in an HTTP server) and SCAN-TO-HDD (a function of saving a scanned image in an HDD).

Each job may be a main job or a sub job. For instance, if scanning is the main job, a main job mentioned above may be a sub job. If copying is the main job, FAX transmission, SCAN-TO-E-mail, SCAN-TO-FTP, SCAN-TO-HTTP and SCAN-TO-HDD may be sub jobs.

The stamps shown in FIG. 7 are mere examples, and any stamp that can specify the importance of a document may be used. Specifically, a stamp other than those shown in FIG. 7 may be used for indicating confidential level. Further, stamps indicating document types other than confidential, strictly confidential and internal use only may be used. In such a case, information of document type and information of sub job execution inhibited/permitted are saved in a table, in correspondence with the stamp or stamps used.

In place of determining whether or not a prescribed stamp is included in the document, or in addition to such a determination, character recognition may be used, to determine whether or not a character or characters representing document type (such as “confidential”, “strictly confidential” or “internal use only”) are included.

Further, the document type may be specified not only by characters but also by document patterns such as a format (document form). For example, assume that documents of confidential level, strictly confidential level and internal use only are created in mutually different specific forms. Then, by extracting the patterns (such as arrangement of ruled lines and frames and line type (solid, dotted or the like)) by image processing, the document type of confidential, strictly confidential or internal use only can be found. The pattern may not be the pattern of the whole document, and only a partial pattern may be used. Among pieces of information obtained by image processing of image data resulting from scanning the document, any piece of information that differs document type by document type can be used for identifying the document type.

Though setting of a sub job is either inhibited or permitted in the limited user table shown in FIG. 4, inhibited sub jobs may be defined in detail, such as the description corresponding to “internal use only” in FIG. 8. The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. An image processing apparatus, comprising:
an input unit that inputs image data;
a setting unit that sets, on said input image data, a sub process to be executed simultaneously with or subsequent to a mainly executed process;
a determining unit that determines whether at least one of user specifying information and data type specifying information specifying type of said input image data inhibits setting or execution of a prescribed sub process on said input image data; and
a limiting unit that inhibits, if it is determined that at least one of said pieces of information inhibits either setting or execution of said prescribed sub process, the setting or execution inhibited for said prescribed sub process.

2. The image processing apparatus according to claim 1, further comprising:
a storage unit that stores a table defining correspondence relation between said at least one of said pieces of information and information indicating inhibition/permission of either setting or execution of said sub process; wherein
said determining unit determines whether said at least one of said pieces of information inhibits either setting or execution of a prescribed sub process, by looking up said table.

3. The image processing apparatus according to claim 2, wherein
said at least one of said pieces of information is the user specifying information, and
said determining unit determines whether or not the user successfully authorized to log-in to said image processing apparatus is inhibited from setting or execution of a prescribed sub process on said image data; or
said at least one of said pieces of information is the data type specifying information of the input image data, and
said type is specified by information representing degree of importance of image data, and
said determining unit determines, by image processing of input image data, whether said information representing the degree of importance is included in the image data, and if it is determined that said information representing the degree of importance is included in the image data, determines whether setting or execution of a prescribed sub process on said image data is inhibited, by looking up said table.

4. The image processing apparatus according to claim 1, wherein
said determining unit determines whether or not conditions for exception for executing said inhibited prescribed sub process are satisfied; and
if it is determined that said conditions for exception are satisfied, said limiting unit executes said inhibited prescribed sub process.

5. A method of operating an image processing apparatus, comprising the steps of
inputting image data to the image processing apparatus;
for said input image data, setting a sub process to be executed simultaneously with or subsequent to a mainly executed process;
determining whether at least one of user specifying information and data type specifying information specifying type of said input image data inhibits setting or execution of a prescribed sub process on said input image data; and
if it is determined that at least one of said pieces of information inhibits setting or execution of said prescribed sub process, inhibiting the setting or execution inhibited for said prescribed sub process.
